(19) United States
(12) Patent Application Publication
(10) Pub. No.: US 2026/0031545 A1
(43) Pub. Date: Jan. 29, 2026

(54) ULTRA-WIDEBAND RECONFIGURABLE REFLECTARRAY ANTENNA

(71) Applicant: TSINGHUA UNIVERSITY, Beijing (CN)

(72) Inventors: Fan YANG, Beijing (CN); Binchao ZHANG, Beijing (CN); Shenheng XU, Beijing (CN); Maokun LI, Beijing (CN)

(21) Appl. No.: 19/267,690

(22) Filed: Jul. 14, 2025

(30) Foreign Application Priority Data
Jul. 23, 2024 (CN) 202410992347.2

(51) Int. Cl. H01Q 15/00; H01Q 1/28; H01Q 5/25; H01Q 15/24

(52) U.S. Cl. CPC H01Q 15/002; H01Q 1/288; H01Q 5/25; H01Q 15/24

(57) ABSTRACT

Provided is an ultra-wideband reconfigurable reflectarray antenna. The ultra-wideband reconfigurable reflectarray antenna includes: a feed antenna and an ultra-wideband reconfigurable reflectarray surface. The feed antenna is disposed at a predetermined position of the ultra-wideband reconfigurable reflectarray surface and configured to provide electromagnetic waves to the ultra-wideband reconfigurable reflectarray surface. The ultra-wideband reconfigurable reflectarray surface includes M×N ultra-wideband reconfigurable reflectarray antenna elements arranged periodically and equidistantly, and is configured to perform ultra-wideband phase modulation on the electromagnetic waves, where each of M and N is a positive integer greater than 2.

The present application claims priority to Chinese Patent Application No. 202410992347.2, titled “ULTRA-WIDEBAND RECONFIGURABLE REFLECTARRAY ANTENNA”, filed on Jul. 23, 2024 with the China National Intellectual Property Administration, which is incorporated herein by reference in its entirety.

### FIELD

The present disclosure relates to the field of satellite communication technologies, and in particular, to an ultra-wideband reconfigurable reflectarray antenna based on polarization conversion and multimode resonance.

### BACKGROUND

Satellite communication is a communication method that uses a satellite as a relay station to transmit or forward radio waves, which can achieve communication between two or more ground stations, a handheld terminal, and a spacecraft and a ground station. Compared with terrestrial communication, the satellite communication has advantages such as a large communication coverage region, maneuverability and flexibility, a wide communication bandwidth, a large capacity, a good channel quality, and stable transmission performance. The satellite communication is widely applied in communication technologies such as emergency communication, and has increasingly become one of important factors driving the development of communication networks. However, due to a long satellite link and large propagation attenuation, for example, attenuation in X, Ku, and Ka frequency bands of a geosynchronous orbit satellite is approximately 200 dB, a satellite communication antenna needs to have a sufficiently high gain. Since the satellite communication has a wide coverage area, a large number of users, and various operation modes, the satellite communication antenna must have a characteristic of wide bandwidth operation or multi-band frequency operation. Moreover, in a high-speed movement scenario, the satellite communication needs to perform a predetermined adjustment according to a target movement speed and direction, thus the satellite communication requires the ability to change a signal radiation characteristic in real time. Facing the above requirements, the satellite communication confronts problems such as a highly complex network, high-cost hardware, and increasing energy consumption. Moreover, more complex signal processing and more expensive energy-consuming hardware are required for satellite communication in operation frequency bands ranging from sub-6G to millimeter waves and terahertz waves. Therefore, researching innovative, efficient, and resource-saving and spectrum-efficient satellite communication solutions is imperative.

A reconfigurable array antenna, with its characteristics of a low cost, low energy consumption, programmability, and ease of deployment, is widely utilized by a researcher for realizing a low-cost satellite communication antenna with beam reconfigurability. However, an existing technology usually can only cover a single frequency band among frequency bands (X/Ku/Ka) commonly used in the satellite communication, or requires a multi-layer stacked co-aperture method or a cross-arranged co-aperture method to increase a bandwidth and the number of operation frequency bands, resulting in a sharp increasement in complexity, system power consumption, and costs of a switching device and a control system. Therefore, there is an urgent need for an ultra-wideband reconfigurable array antenna capable of covering the frequency bands ranging from X to Ka using only a single phase-adjusting element to satisfy satellite communication requirements across different frequency bands.

### SUMMARY

The present disclosure provides an ultra-wideband reconfigurable reflectarray antenna to solve a problem that a reconfigurable array antenna can only cover a single frequency band among frequency bands commonly used in satellite communication, or requires a multi-layer stacked co-aperture method or a cross-arranged co-aperture method to increase a bandwidth and the number of operation frequency bands, resulting in a sharp increasement in complexity, system power consumption, and costs of a switching device and a control system.

Embodiments of the present disclosure provide an ultra-wideband reconfigurable reflectarray antenna. The ultra-wideband reconfigurable reflectarray antenna includes: a feed antenna and an ultra-wideband reconfigurable reflectarray surface. The feed antenna is disposed at a predetermined position of the ultra-wideband reconfigurable reflectarray surface and configured to provide electromagnetic waves to the ultra-wideband reconfigurable reflectarray surface. The ultra-wideband reconfigurable reflectarray surface includes M×N ultra-wideband reconfigurable reflectarray antenna elements arranged periodically and equidistantly, and is configured to perform ultra-wideband phase modulation on the electromagnetic waves, where each of M and N is a positive integer greater than 2.

Optionally, polarization of the feed antenna is in a linear polarization form or a circular polarization form.

Optionally, the predetermined position is a position directly in front of the ultra-wideband reconfigurable reflectarray surface or a position obtained by rotating, the position directly in front of the ultra-wideband reconfigurable reflectarray surface, clockwise or counterclockwise by a predetermined angle around the ultra-wideband reconfigurable reflectarray surface.

Optionally, each of the M×N ultra-wideband reconfigurable reflectarray antenna elements includes an ultra-wideband polarization-converting metal patch, a first switching device, a second switching device, a third switching device, and a fourth switching device, a dielectric substrate, and a metal ground plane. The ultra-wideband polarization-converting metal patch is a cruciform structure rotated by 45° around a center of the ultra-wideband reconfigurable reflectarray antenna element and is disposed on a surface of the dielectric substrate. The first switching device, the second switching device, the third switching device, and the fourth switching device are disposed on four branches of the ultra-wideband polarization-converting metal patch, respectively. The metal ground plane is located below the dielectric substrate, and a dielectric layer or an air layer is formed between the metal ground plane and the dielectric substrate.

Optionally, the ultra-wideband polarization-converting metal patch has a plurality of resonant modes, and the plurality of resonant modes operate at different frequency bands to implement ultra-wideband phase reconfigurability.

Optionally, the first switching device is arranged opposite to the second switching device, the third switching device is arranged at a right side of the first switching device and a left side of the second switching device, and the fourth switching device is arranged at a left side of the first switching device and a right side of the second switching device.

Optionally, on-off states of the first switching device, the second switching device, the third switching device, and the fourth switching device allow each of the M×N ultra-wideband reconfigurable reflectarray antenna elements to switch between two states within a predetermined operation frequency band. The two states include a state 0 and a state 1. The ultra-wideband reconfigurable reflectarray antenna element in the state 0 and the ultra-wideband reconfigurable reflectarray antenna element in the state 1 have approximately the same polarization-converting reflection amplitude and a polarization-converting reflection phase difference of 180°.

Optionally, the ultra-wideband reconfigurable reflectarray antenna element is in the state 0, when the first switching device and the second switching device are turned off and the third switching device and the fourth switching device are turned on.

Optionally, the ultra-wideband reconfigurable reflectarray antenna element is in the state 1, when the first switching device and the second switching device are turned on and the third switching device and the fourth switching device are turned off.

Optionally, the dielectric substrate is made of a microwave-grade material.

The ultra-wideband reconfigurable reflectarray antenna proposed in the embodiments of the present disclosure may realize dynamic adjustment and control of a radiation beam over an ultra-wideband by constructing a multi-mode resonant structure and efficiently utilizing each resonant mode and coupling between the resonant modes, thereby supporting the use of a single aperture to cover a common satellite communication frequency band. The antenna has a simple structure, a small number of switches, a simplified control system, low system power consumption and costs, which is beneficial to large-scale applications.

A part of additional aspects and advantages of the present disclosure are given in the following description, and another part of the additional aspects and advantages become apparent from the following description, or can be learned from practicing of the present disclosure.

### BRIEF DESCRIPTION OF THE DRAWINGS

The above and/or additional aspects and advantages of the present disclosure become more apparent and more understandable from the following description of embodiments taken in conjunction with the accompanying drawings.

FIG. 1 is a schematic structural diagram of an ultra-wideband reconfigurable reflectarray antenna provided in an embodiment of the present disclosure;

FIG. 2 is a front view of a structure of an ultra-wideband reconfigurable reflectarray antenna element provided in an embodiment of the present disclosure;

FIG. 3 is a top view of a structure of an ultra-wideband reconfigurable reflectarray antenna element provided in an embodiment of the present disclosure;

FIG. 4 is a diagram showing a correspondence between a state of an ultra-wideband reconfigurable reflectarray antenna element and on-off states of switches provided in an embodiment of the present disclosure;

FIG. 5 is a schematic diagram of an equivalent structure of an ultra-wideband reconfigurable reflectarray antenna element in a state 0 provided in an embodiment of the present disclosure;

FIG. 6 is a schematic diagram of an equivalent structure of an ultra-wideband reconfigurable reflectarray antenna element in a state 1 provided in an embodiment of the present disclosure;

FIG. 7 is a diagram of polarization-converting reflection phases of a reconfigurable reflectarray antenna element in two states provided in an embodiment of the present disclosure;

FIG. 8 is a diagram of polarization-converting reflection amplitudes of a reconfigurable reflectarray antenna element in two states provided in an embodiment of the present disclosure;

FIG. 9 is a simulated current distribution diagram of a resonant mode f₁ of an equivalent structure of a reconfigurable reflectarray antenna element in a state 1 provided in an embodiment of the present disclosure;

FIG. 10 is a simulated current distribution diagram of a resonant mode f₂ of an equivalent structure of a reconfigurable reflectarray antenna element in a state 1 provided in an embodiment of the present disclosure;

FIG. 11 is a simulated current distribution diagram of a resonant mode f₃ of an equivalent structure of a reconfigurable reflectarray antenna element in a state 1 provided in an embodiment of the present disclosure;

FIG. 12 is a simulated gain and corresponding aperture efficiency of a reconfigurable reflectarray antenna provided in an embodiment of the present disclosure;

FIG. 13 is a simulated radiation beam scanning pattern of a reconfigurable reflectarray antenna at 11 GHz provided in an embodiment of the present disclosure;

FIG. 14 is a simulated radiation beam scanning pattern of a reconfigurable reflectarray antenna at 19.5 GHz provided in an embodiment of the present disclosure; and

FIG. 15 is a simulated radiation beam scanning pattern of a reconfigurable reflectarray antenna at 29.5 GHz provided in an embodiment of the present disclosure.

### DETAILED DESCRIPTION

Embodiments of the present disclosure are described in detail below with reference to examples thereof as illustrated in the accompanying drawings, throughout which same or similar elements, or elements having same or similar functions, are denoted by same or similar reference numerals. The embodiments described below with reference to the accompanying drawings are illustrative only, and are intended to explain, rather than limiting, the present disclosure.

An ultra-wideband reconfigurable reflectarray antenna in an embodiment of the present disclosure is described below with reference to the accompanying drawings.

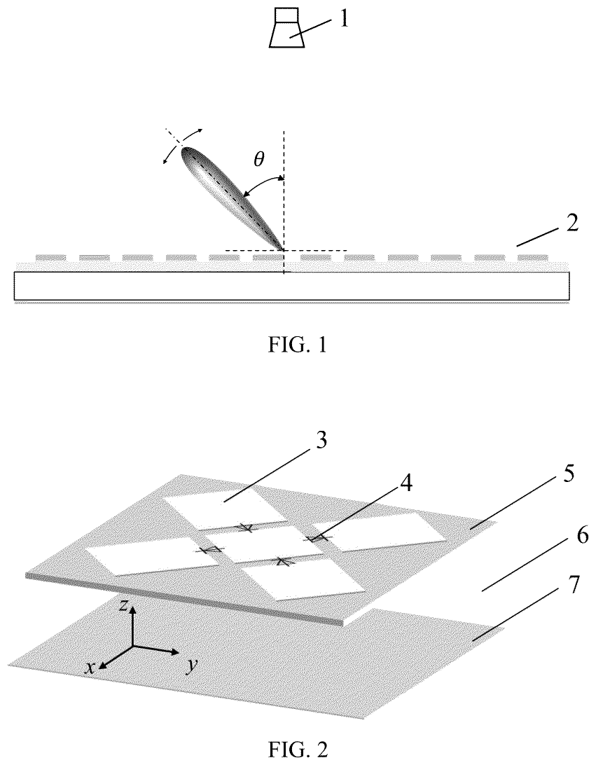

FIG. 1 is a schematic structural diagram of an ultra-wideband reconfigurable reflectarray antenna provided in an embodiment of the present disclosure.

As shown in FIG. 1, the ultra-wideband reconfigurable reflectarray antenna includes a feed antenna 1 and an ultra-wideband reconfigurable reflectarray surface 2.

The feed antenna 1 is disposed at a predetermined position of the ultra-wideband reconfigurable reflectarray surface and configured to provide electromagnetic waves to the ultra-wideband reconfigurable reflectarray surface. The ultra-wideband reconfigurable reflectarray surface 2 includes M×N ultra-wideband reconfigurable reflectarray antenna elements arranged periodically and equidistantly, and is configured to modulate phases of the electromagnetic waves emitted by the feed antenna 1 within an ultra-wideband, where each of M and N is a positive integer greater than 2. M=N=16 is taken as an example in the following description.

Specifically, a polarization form of the feed antenna 1 is linear polarization or circular polarization. The feed antenna 1 may be disposed at a position directly in front of the ultra-wideband reconfigurable reflectarray surface or a position obtained by rotating, the position directly in front of the ultra-wideband reconfigurable reflectarray surface, clockwise or counterclockwise by a predetermined angle around the ultra-wideband reconfigurable reflectarray surface.

In some embodiments, each of the M×N ultra-wideband reconfigurable reflectarray antenna elements includes an ultra-wideband polarization-converting metal patch, a first switching device, a second switching device, a third switching device, and a fourth switching device, a dielectric substrate, and a metal ground plane. The ultra-wideband polarization-converting metal patch is a cruciform structure rotated by 45° around a center of the ultra-wideband reconfigurable reflectarray antenna element and is disposed on a surface of the dielectric substrate. The first switching device, the second switching device, the third switching device, and the fourth switching device are disposed on four branches of the ultra-wideband polarization-converting metal patch, respectively. The metal ground plane is located below the dielectric substrate, and a dielectric layer or an air layer is formed between the metal ground plane and the dielectric substrate.

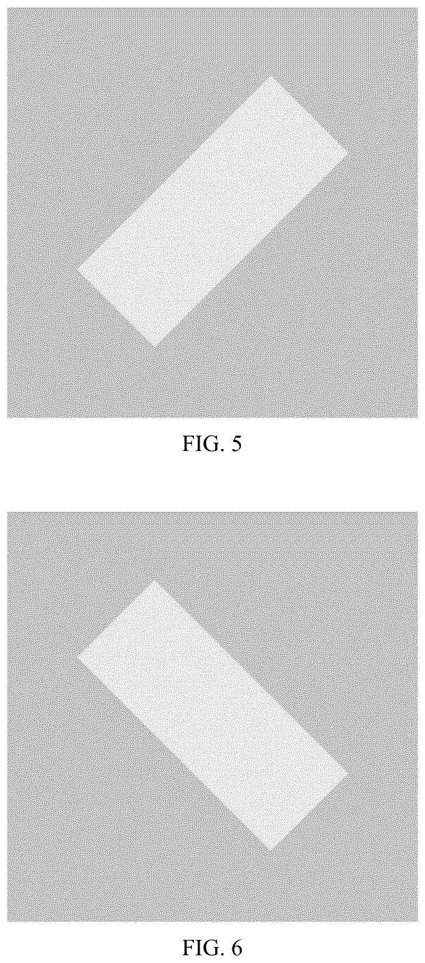

Specifically, as shown in FIG. 5, each ultra-wideband reconfigurable reflectarray antenna element 2 includes an ultra-wideband polarization-converting metal patch 3, a first switching device 41, a second switching device 42, a third switching device 43, and a fourth switching device 44, a dielectric substrate 5, a dielectric layer or an air layer 6, and a metal ground plane 7. The ultra-wideband polarization-converting metal patch 3 is a cruciform structure rotated by 45° around a center of the ultra-wideband reconfigurable reflectarray antenna element and is disposed on an upper surface of the dielectric substrate 5. The first switching device 41, the second switching device 42, the third switching device 43, and the fourth switching device 44 are disposed on four metal branches of the ultra-wideband polarization-converting metal patch 3. The metal ground plane 7 is located below the dielectric substrate 5, with a dielectric layer or an air layer 6 formed between the metal ground plane 7 and the dielectric substrate 5. The dielectric substrate 5 is made of a microwave-grade material.

In some embodiments, the first switching device 41 is arranged opposite to the second switching device 42. The third switching device 43 is arranged at a right side of the first switching device 41 and a left side of the second switching device 42. The fourth switching device 44 is arranged at a left side of the first switching device 41 and a right side of the second switching device 42.

Specifically, as shown in FIG. 3, by controlling on-off states of the first switching device 41, the second switching device 42, the third switching device 43, and the fourth switching device 44, the ultra-wideband reconfigurable reflectarray antenna element 2 may realize switching between two states within its operation frequency band, thereby enabling beam scanning, beam shaping, and other functions within the ultra-wideband. The two states include a state 0 and a state 1.

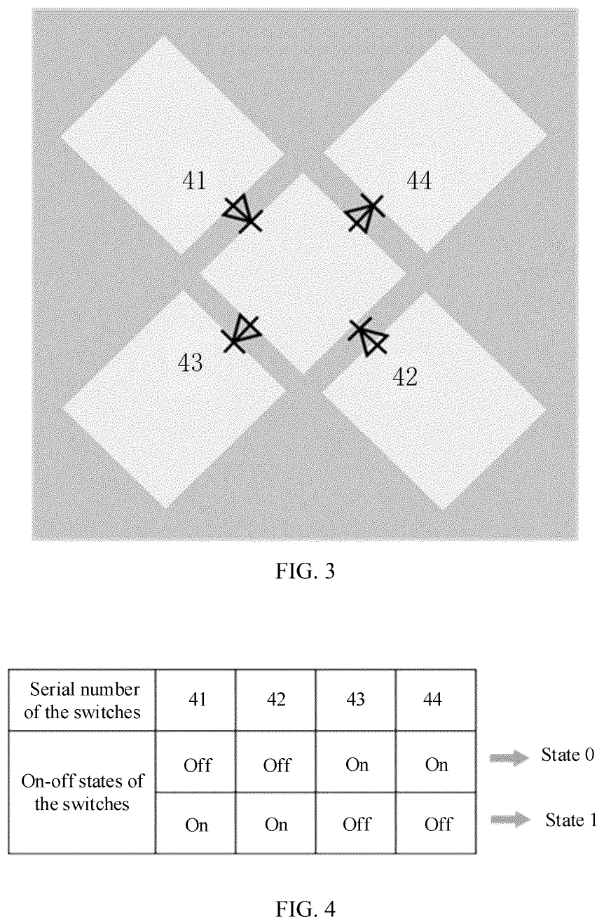

As shown in FIG. 4, a correspondence between the on-off states of the first switching device 41, the second switching device 42, the third switching device 43, and the fourth switching device 44 and the two states of the ultra-wideband reconfigurable reflectarray antenna element 2 is described below.

As shown in FIG. 5 and FIG. 6, the ultra-wideband reconfigurable reflectarray antenna element 2 is in the state 0, when the first switching device 41 and the second switching device 42 are turned off and the third switching device 43 and the fourth switching device 44 are turned on. The ultra-wideband reconfigurable reflectarray antenna element 2 is in the state 1, when the first switching device 41 and the second switching device 42 are turned on and the third switching device 43 and the fourth switching device 44 are turned off.

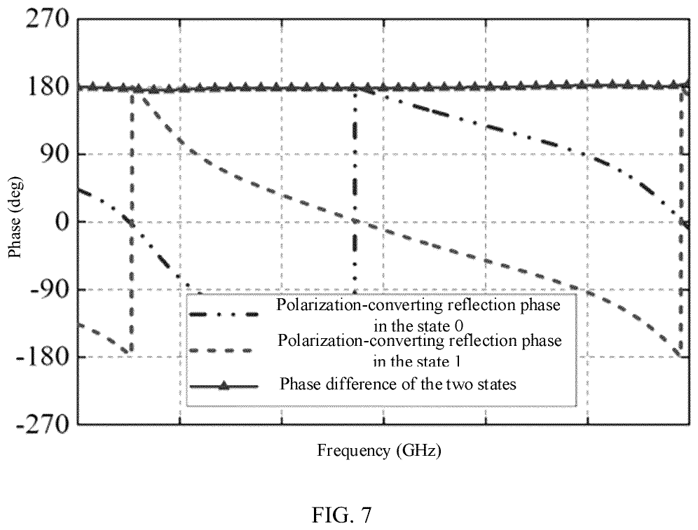

As shown in FIG. 7, the ultra-wideband reconfigurable reflectarray antenna element in the state 0 and the ultra-wideband reconfigurable reflectarray antenna element in the state 1 have a constant polarization-converting reflection phase difference of 180°, that is, 1-bit phase modulation is performed.

In some embodiments, the ultra-wideband polarization-converting metal patch 3 has a plurality of resonant modes, and the plurality of resonant modes operate at different frequency bands to implement ultra-wideband phase modulation.

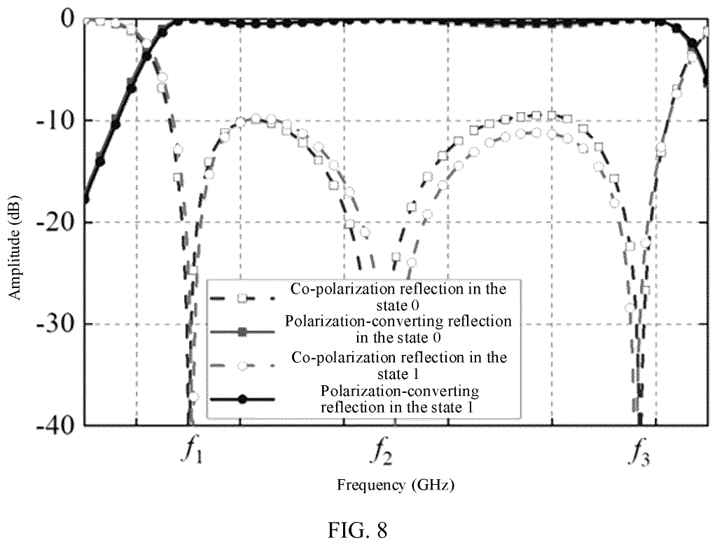

Specifically, as shown in FIG. 8, in the two states, the ultra-wideband reconfigurable reflectarray antenna element 2 has three resonant modes, which include operating in half-wavelength resonance (f₁), operating in hybrid resonance (f₂), and operating in 1.5 wavelength resonance (f₃), respectively. A frequency of f₃ is approximately three times a frequency of f₁, and f₂ ranges from f₁ to f₃. By reasonably setting a position of the resonant mode f₂, good polarization-converting reflection performance may be achieved between f₁ and f₃, with a polarization-converting reflection coefficient higher than −1 dB and a co-polarization reflection coefficient lower than −10 dB. Therefore, this structure can realize an ultra-wideband 1-bit reconfigurable reflectarray antenna with approximately 3:1 frequency ratio and a relative bandwidth of approximately 100%.

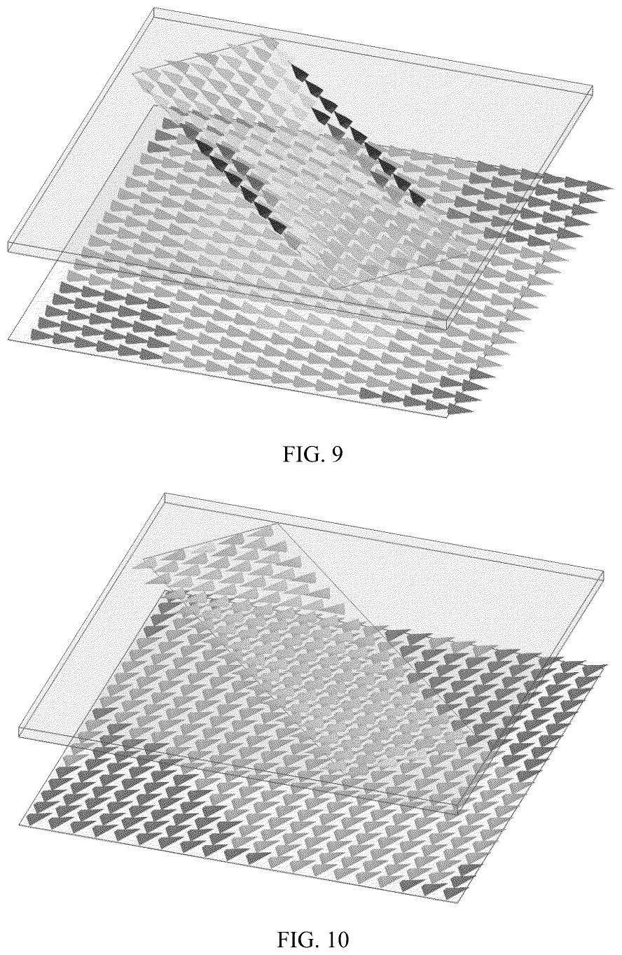

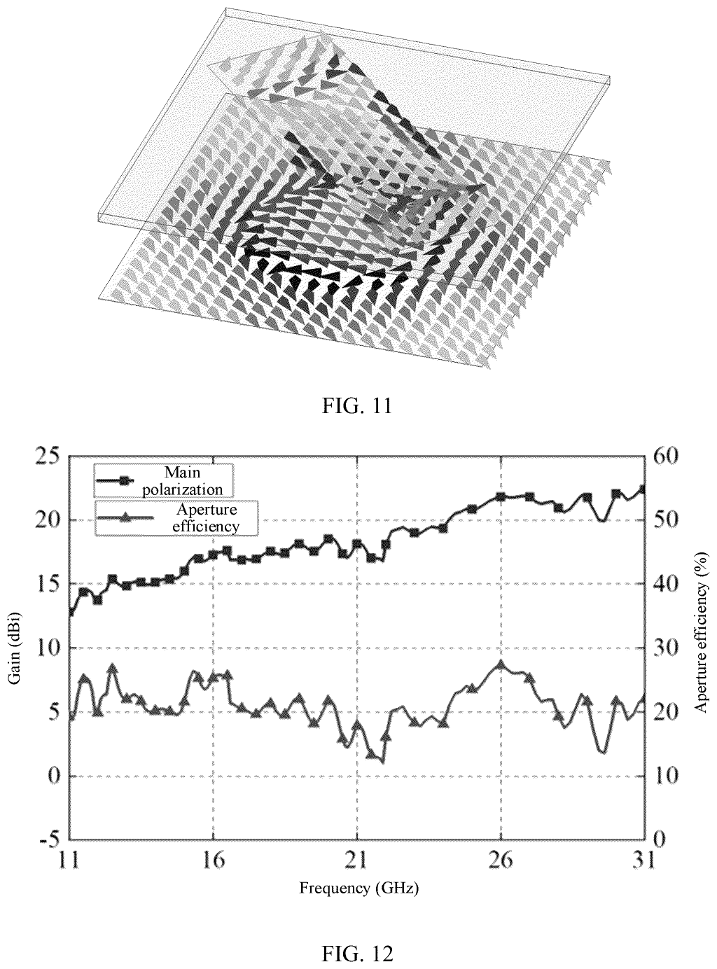

Further, as shown in FIG. 9, current distribution of the ultra-wideband reconfigurable reflectarray antenna element 2 in the resonant mode f₁ is along a long side of the metal patch, approximating a first-order resonant mode. As shown in FIG. 10, current distribution of the ultra-wideband reconfigurable reflectarray antenna element 2 in the resonant mode f₂ is along a short side of the metal patch, approximating a first-order resonant mode. As shown in FIG. 11, current distribution of the ultra-wideband reconfigurable reflectarray antenna element 2 in the resonant mode f₃ is also along the long side of the metal patch, approximating a third-order resonant mode. Such a polarization-converting reflection structure with multi-mode resonance enables an operation bandwidth of the reconfigurable reflectarray antenna to be broadened as much as possible.

Further, as shown in FIG. 12, in the embodiments of the present disclosure, the feed antenna 1 is placed at the position directly in front of the ultra-wideband reconfigurable reflectarray surface for a simulation experiment. It can be seen from FIG. 12 that an ultra-wideband reconfigurable reflectarray antenna structure constructed in the embodiments of the present disclosure can achieve a beam focusing function within an ultra-wideband (ranging from 11 GHz to 31 GHz), with aperture efficiency of approximately 20%.

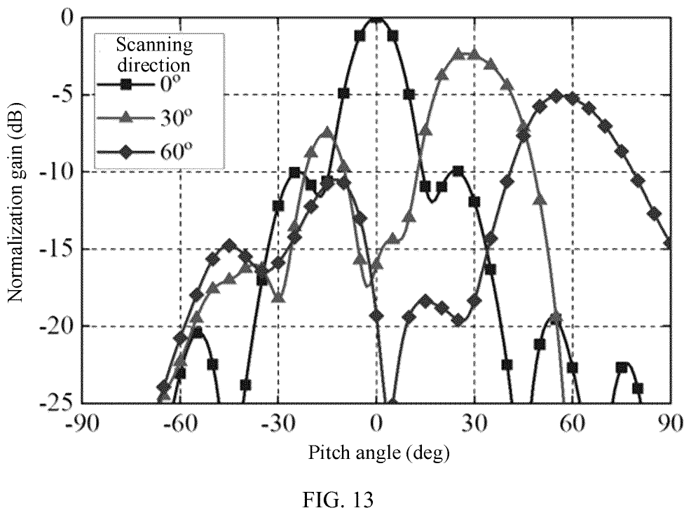

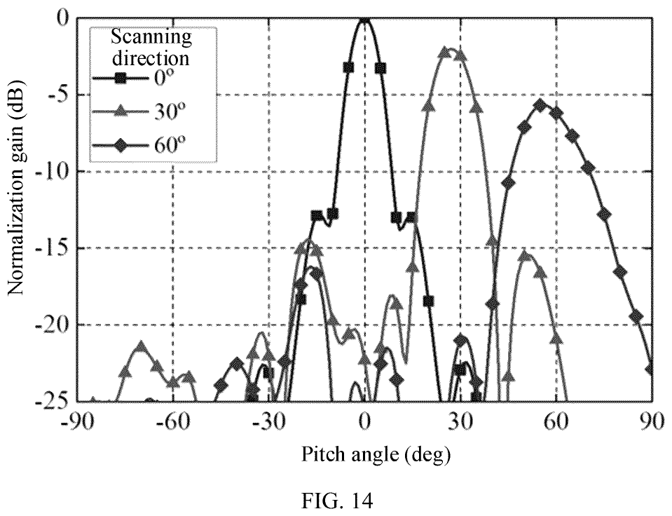

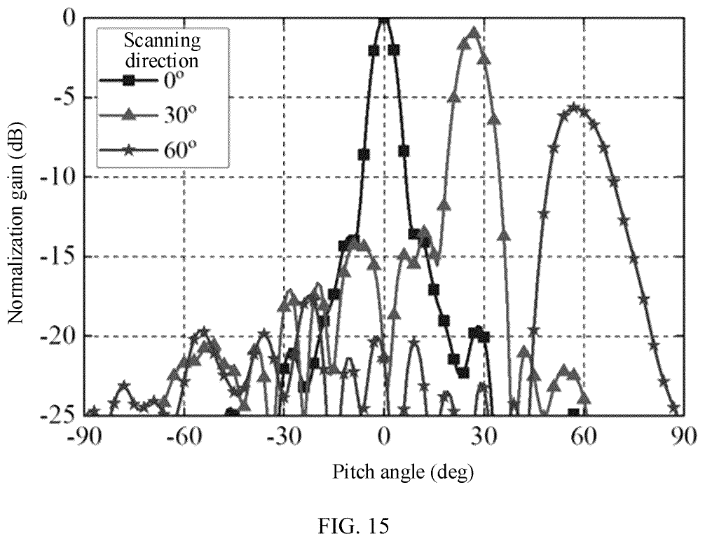

Further, as shown in FIG. 13 to FIG. 15, in the embodiments of the present disclosure, fast beam scanning within an ultra-wide frequency band between +60° and −60° can be achieved, verifying a dynamic beam scanning function of the ultra-wideband reconfigurable reflectarray antenna.

The ultra-wideband reconfigurable reflectarray antenna proposed according to the embodiments of the present disclosure has the following beneficial effects.

A first beneficial effect is that dynamic regulation and control of a radiation beam can be achieved within an ultra-wideband by constructing a multi-mode resonant structure and efficiently utilizing each resonant mode and coupling between the resonant modes, thereby supporting the use of a single aperture to cover a common satellite communication frequency band.

A second beneficial effect is that the antenna has a simple structure, a small number of switches, a simplified control system, low system power consumption and costs, which is beneficial to large-scale applications.

In the description of this specification, description with reference to the terms “an embodiment”, “some embodiments”, “examples” “specific examples”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or N embodiments or examples in a suitable manner. In addition, those skilled in the art can combine different embodiments or examples and the features of the different embodiments or examples described in this specification without contradicting each other.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “N” means at least two, such as two, three, etc., unless otherwise specifically defined.

What is claimed is:

1. An ultra-wideband reconfigurable reflectarray antenna, comprising:
a feed antenna; and
an ultra-wideband reconfigurable reflectarray surface, wherein
the feed antenna is disposed at a predetermined position of the ultra-wideband reconfigurable reflectarray surface and configured to provide electromagnetic waves to the ultra-wideband reconfigurable reflectarray surface; and
the ultra-wideband reconfigurable reflectarray surface comprises M×N ultra-wideband reconfigurable reflectarray antenna elements arranged periodically and equidistantly, and is configured to perform ultra-wideband phase modulation on the electromagnetic waves, where each of M and N is a positive integer greater than 2.

2. The ultra-wideband reconfigurable reflectarray antenna according to claim 1, wherein polarization of the feed antenna is in a linear polarization form or a circular polarization form.

3. The ultra-wideband reconfigurable reflectarray antenna according to claim 1, wherein the predetermined position is a position directly in front of the ultra-wideband reconfigurable reflectarray surface or a position obtained by rotating, the position directly in front of the ultra-wideband reconfigurable reflectarray surface, clockwise or counterclockwise by a predetermined angle around the ultra-wideband reconfigurable reflectarray surface.

4. The ultra-wideband reconfigurable reflectarray antenna according to claim 1, wherein:
each of the M×N ultra-wideband reconfigurable reflectarray antenna elements comprises an ultra-wideband polarization-converting metal patch, a first switching device, a second switching device, a third switching device, and a fourth switching device, a dielectric substrate, and a metal ground plane,
wherein the ultra-wideband polarization-converting metal patch is a cruciform structure rotated by 45° around a center of the ultra-wideband reconfigurable reflectarray antenna element and is disposed on a surface of the dielectric substrate;
wherein the first switching device, the second switching device, the third switching device, and the fourth switching device are disposed on four branches of the ultra-wideband polarization-converting metal patch, respectively; and
wherein the metal ground plane is located below the dielectric substrate, and a dielectric layer or an air layer is formed between the metal ground plane and the dielectric substrate.

5. The ultra-wideband reconfigurable reflectarray antenna according to claim 4, wherein the ultra-wideband polarization-converting metal patch has a plurality of resonant modes, and the plurality of resonant modes operate at different frequency bands to implement ultra-wideband phase reconfigurability.

6. The ultra-wideband reconfigurable reflectarray antenna according to claim 4, wherein the first switching device is arranged opposite to the second switching device, the third switching device is arranged at a right side of the first switching device and a left side of the second switching device, and the fourth switching device is arranged at a left side of the first switching device and a right side of the second switching device.

7. The ultra-wideband reconfigurable reflectarray antenna according to claim 6, wherein:
on-off states of the first switching device, the second switching device, the third switching device, and the fourth switching device allow each of the M×N ultra-wideband reconfigurable reflectarray antenna elements to switch between two states within a predetermined operation frequency band,
wherein the two states comprise a state 0 and a state 1, and the ultra-wideband reconfigurable reflectarray antenna element in the state 0 and the ultra-wideband reconfigurable reflectarray antenna element in the state 1 have approximately the same polarization-converting reflection amplitude and a polarization-converting reflection phase difference of 180°.

8. The ultra-wideband reconfigurable reflectarray antenna according to claim 7, wherein the ultra-wideband reconfigurable reflectarray antenna element is in the state 0, when the first switching device and the second switching device are turned off and the third switching device and the fourth switching device are turned on.

9. The ultra-wideband reconfigurable reflectarray antenna according to claim 7, wherein the ultra-wideband reconfigurable reflectarray antenna element is in the state 1, when the first switching device and the second switching device are turned on and the third switching device and the fourth switching device are turned off.

10. The ultra-wideband reconfigurable reflectarray antenna according to claim 4, wherein the dielectric substrate is made of a microwave-grade material.
